(19) United States
(12) Patent Application Publication
(10) Pub. No.: US 2018/0040258 A1
(43) Pub. Date: Feb. 8, 2018

(54) METHOD AND SYSTEM FOR TRANSMITTING TACTILE INSTRUCTIONS TO A HUMAN BODY

(71) Applicant: Nordin Kouache, Frankfurt am Main (DE)

(72) Inventor: Nordin Kouache, Frankfurt am Main (DE)

(21) Appl. No.: 15/033,072

(22) PCT Filed: Oct. 10, 2014
(86) PCT No.: PCT/DE2014/100355

§ 371 Date: Jul. 13, 2016

(30) Foreign Application Priority Data
Oct. 29, 2013 (DE) 10 2013 017 940.8
Oct. 29, 2013 (DE) 20 2013 009 744.2
May 7, 2014 (DE) 10 2014 006 664.9
Jul. 24, 2014 (DE) 10 2014 110 476.5

(51) Int. Cl. G09B 19/00; A63B 24/00

(52) U.S. Cl. CPC G09B 19/00; A63B 24/0062

(57) ABSTRACT

A device designed to be worn on the human body includes attachment means which place the device such that it rests directly against a body part, and at least one functional module which is connected to the attachment means, wherein the functional module comprises a wireless receiver and at least one tactile stimulation module. The stimulation module is designed to forward tactile stimuli to the body part to which it is attached. The wireless receiver is designed to receive instructions and to activate the stimulation module.

### BACKGROUND

### Technical Field

The present disclosure provides a method and a device for the tactile control of a person with a tactile stimuli (vibrotactile, electrotactile and mechanotactile).

### Description of the Related Art

The basic problem were complaints of sportspersons and patients in rehabilitation treatment about the use of sports apps, cardio machines, heart rate belts, heart rate monitors, smartphones, mobile pulse oximeters (oxygen saturation of the blood), wearable computers (body-borne computers of any type), sports wristbands, mobile sphygmomanometers and all mobile measuring instruments which measure vital parameters (pulse rate, warmth, blood pressure, humidity, etc.); all these pieces of equipment can measure the different parameters but there is no adjustment of the training activity to the present circumstances and preconditions.

On the one hand, it should be avoided that training is not hard enough, i.e., ineffective on the whole, but overexertion and associated unhealthy and damaging effects are to be avoided as well. It is not possible to control training in an optimal manner when using this equipment and methods.

EP 0029166 A1 describes a device for measuring blood pressure which measures the resting pulse rate.

DE 102004013931 A1 describes a medical breast belt which can detect heart signals on the body surface.

EP 2096989 B1 describes a measuring device for the non-invasive determination of at least one physiological parameter, including at least one diagnostic sensor unit for producing measurement signals and an evaluation unit for processing the measurement signals.

Further aspects result from the availability of GPS (Global Positioning System) systems. These navigation devices and navigation methods are becoming more and more popular. Such navigation devices are used in cars or in a mobile fashion. A large part of these navigation systems are used via mobile phones and portable equipment.

A characteristic of known navigation devices is that, as a rule, attention is continuously drawn to the screen of the smartphone (mobile navigation devices), which is a considerable risk in road traffic situations.

### BRIEF SUMMARY

The present disclosure provides a method and a device for individual tactile control. The individual preconditions of the user (vital parameters) are taken into account as precisely as possible in order to ensure optimal training. Another part of the present disclosure is the use as a navigation system in which guidance to a destination is experienced in a haptic manner by the vibrations of the wristbands and attention is not diverted too much by a screen. There is also a need to provide a multi-use navigation method which makes it possible to pay more attention to the environment during navigation.

If further sensors are included, embodiments of the present disclosure can serve to detect electrical signals on the body surface in order to perform relevant monitoring and training functions.

To save time and cost, many people prefer to do sports using home fitness equipment rather than train in a fitness club or gymnasium. In other cases, it may be impossible or require much effort to leave the home, for example due to a handicap or illness, but it is not possible to control the person in a precise manner during training since the equipment only displays the upper pulse rate limit or the lower pulse rate limit (the training range). However, the correct adjustment of the training activity to the circumstances present in each individual case is a requirement for training to be effective. On the one hand, it should be avoided that training is not hard enough, i.e., ineffective on the whole, but overexertion, or unhealthy and damaging training, is to be avoided as well.

The starting point of the present disclosure are complaints and concerns of sportspersons and patients in rehabilitation treatment about the use of sports apps, cardio machines, heart rate belts, heart rate monitors, smartphones, bicycles, wearable computers (body-borne computers of any type) and sports wristbands. All these pieces of equipment can measure the heart rate but it is not possible to control the user in a precise manner during training since the equipment only displays the upper pulse rate limit or the lower pulse rate limit (the training range). In most cases, this is done with visual or acoustic signals.

The system described herein can be used to avoid this. Using tactile stimuli (vibrotactile, electrotactile and mechanotactile), the user is guided to the training ranges set by the system after an initial test. This is done substantially without acoustic and visual signals. The training ranges are controlled dynamically and transmitted in a tactile manner. If suitably shaped, the system can in addition be incorporated in cardio machines, clothes, heart rate belts, watches, smartphones, walking sticks, glasses, shoes, swimming accessories, jewellery, bicycles, wearable computers, etc.

Hereinafter a method and a device will be described which is designed such that it can be produced at very low cost. Many other embodiments are conceivable if the shape, material selection, type and position of the sensors (mechanotactile, electrotactile and vibrotactile sensors) are changed or other manufacturing processes are used. Therefore it is expressly stated that the claims are intended to cover all possible combinations.

The aforesaid object is achieved with a device and a method according to the claims.

### BRIEF DESCRIPTION OF THE SEVERAL VIEWS OF THE DRAWINGS

What follows is a description of the figures to which reference is made in the detailed description below.

In said figures:

FIG. 1 shows a schematic diagram of a wristband including the essential functional elements that are involved in the method according to the present disclosure;

FIG. 2 shows a wristband including two vibration elements which are arranged on the right and left;

FIG. 3 shows a wristband including sensors for recording data;

FIG. 4 shows the arrangement of the wristbands on the body of a person;

FIG. 5 shows the screenshots of an app/application that controls the wristbands; and

FIG. 6 shows a navigation application/APP that activates each of the units of the present disclosure.

### DETAILED DESCRIPTION

The device according to the present disclosure is designed to be worn on the human body, using attachment means which place the device in such a manner that it rests directly against a body part. Bands, short pockets in items of clothing or shoes or other receptacles can be used for this purpose, provided they ensure that the device is in physical contact with the user. The device is potentially a small mobile unit, so that it is no burden when worn. The shape factor should not exceed 3×3×1 cm, if possible. The shape factor should not exceed that of a wristwatch and should be similar, if possible; the same should go for the weight. This device includes at least one functional module which is connected to the attachment means. The functional module comprises a wireless receiver and at least one tactile stimulation module. The tactile stimulation module is designed to forward tactile stimuli to the body part to which it is attached. The wireless receiver is designed to receive instructions and to activate the stimulation module. Usually, the wireless receiver is a Bluetooth unit or a WLAN unit and/or a Zigbee unit which is capable of receiving instructions or transmitting sensor data, as will be described below. Usually, a connection is made to a mobile terminal, such as a mobile smartphone, on which a program code can run which will then produce instruction to the stimulation module which are transmitted to the device according to the present disclosure through the wireless interface. However, the functional module may also be designed to work autonomously and only to be programmed through the wireless interface. This means certain information is prepared on the mobile terminal/smartphone or on a stationary terminal/PC and is then transmitted to the device according to the present disclosure. In this case, the device according to the present disclosure includes a suitable processor and main memory and, if appropriate, a GPS receiver to carry out autonomous data processing, e.g., in the form of navigation. This means it is a unit which potentially works offline when it is in use. Alternatively the user can select between the two modes, i.e., online/offline.

As explained above, the attachment means can be a closable band (wristband/ankle band) and/or a belt (thoracic belt) and/or a cap/headband and/or a pocket/receptacle in items of clothing, watches, smartphones, walking sticks, glasses, shoes, gloves, swimming accessories, jewellery, bicycle grips and/or saddles which provide for direct contact with a body part.

In another embodiment, the device comprises several stimulation modules at different positions within the functional module which are spaced apart, so that the different positions can be detected by the body part. This makes it possible for the user to identify which stimulation module has been activated. Each stimulation module can then be assigned another logical function. For example, the left stimulation module can be associated with turning to the left, the right stimulation module with turning to the right. Both stimulation modules can be associated with a start or a stop. The logical meaning of the stimulation modules can be set in the relevant application on the smartphone. It should of course be understood that one device may include a plurality of stimulation modules which all have a different function.

To provide further information intended to distinguish the information, the stimulation module can produce different tactile stimulation patterns which can be activated from outside, comprising one or more of the following parameters: intensity, frequency, duration, time interval, signal sequence.

The intensity can be the strength of the vibration. The frequency can be the repetition of the vibration or the vibration frequency itself. The duration can be the length of the vibration. The time interval can be the time between the individual vibration intervals. A signal sequence can be a slow increase in vibration intensity or certain patterns of vibration sequences.

The stimulation module can work in a vibrotactile, electrotactile and mechanotactile manner. In the vibrotactile type, vibrations are produced by an element which for example works with a balance/unbalance or with piezo elements. As a result, a vibration is produced. If the module works in an electrotactile manner, small currents will flow which give a stimulus to the skin. If the module works in a mechanotactile manner, mechanical elements are moved which then make contact with the user's skin.

In another embodiment, the device comprises at least two units, each of which includes an attachment means, functional module and stimulation module, which can be arranged on a body part, so that they are spaced apart but can be controlled jointly and/or selectively with a central unit, wherein the central unit in some cases includes a navigation application and the directional instructions can be transmitted to the relevant units. This approach allows, for example, to work with two wristbands in which the units according to the present disclosure are included, so that, if the user is running, a navigation instruction can be given such that the left unit indicates that a turn to the left should be made and the right unit indicates that a turn to the right should be made. Furthermore, the units may include a button thereon which can be pressed by the user to obtain a navigation instruction at any time. Alternatively it can also be detected that one of the units is shaken violently and this can be regarded as information input. If for example a user approaches a crossing and no navigation instruction has been given, the user can press the button, thus causing navigation information to be transmitted. In some cases, a stimulus provided by both units can indicate that the user should continue straight ahead. Alternatively a special vibration pattern of the two units can be associated with the start or arrival at the destination. A plurality of vibrations or stimulation patterns can be envisaged. If combined with sensors, the left unit can also be associated with the fact that a defined threshold is not reached and the right unit can be associated with the fact that a defined threshold has been exceeded. All this information can be transmitted to the user without him being required to look at a display of a device.

These two units can be wristbands/ankle bands which can in some cases be attached to the right arm/foot and left arm/foot in order to receive right and left stimuli from the stimulation modules. Or the units can be attached to the left and right shoes in order to receive right and left stimuli from the stimulation modules.

The units can also be attached to the left and right grips of a bicycle handlebar in order to receive right and left stimuli from the stimulation modules. Other vehicles and their handlebars or steering wheels can also be provided with such sensors in their right and left areas. These vehicles can be cars, motorcycles, ships, aeroplanes, etc.

It can also be possible to attach the units in left and right gloves, or incorporate them therein, in order to receive right and left stimuli from the stimulation modules.

The units can be attached in left and right areas of an item of clothing in order to receive right and left stimuli from the stimulation modules.

In another embodiment, the functional module includes sensors for detecting states of the user, such as one or more of the following: pulse rate sensor, blood pressure sensor, acceleration sensor, thermosensor, infrared sensor; which are recorded and can be transmitted to central mobile units, in some cases using a transmitter in the functional module. These sensors can identify forms of movement of the user, such as for example squats, fast or slow running. The device can also detect a state of the user, potentially with the pulse rate sensor and the blood pressure sensor. The same goes for the temperature sensor which can detect whether the user has a fever. Based on this information, a suitable feedback can be directly given to the user, so that he will become aware of the fact that his state of health is not in the normal range and he should take suitable measures. Alternatively it is of course possible to record training programmes which show how often and how fast a user has trained with a defined intensity. This data can then be entered in a database and provide an overview of training. The relevant stimulation modules can also be used to ask a user to train faster or slower if relevant training parameters in the form of thresholds and curves are not reached or exceeded. Usually, the evaluation programs run on the smartphone to which the device according to the present disclosure is connected but monitoring can in part also be done by the device according to the present disclosure itself. In some cases, parameter thresholds and the corresponding training curves can be monitored by the units themselves using simple algorithms. The relevant curves are transmitted to the units in advance, either wirelessly or through a USB interface.

This means the sensors activate the stimulation modules, such as when limits are exceeded/not reached and/or curves and/or increase data are/is exceeded/not reached.

Based on the information from the sensors, the stimulation modules can be activated such that training methods and prescribed load values, such as extent, duration of load, duration of breaks, repetitions, intensity such as frequency, speed, load, can be controlled.

If two units are used, one unit can serve as master which controls the other unit, wherein the unit which serves as master may in some cases include further modules which provide for autonomous navigation and/or recording and processing of sensor information, in order to transmit control signals to the slave units. As described above, the offline functionality is implemented in the units in this way. The units are configured appropriately in an online mode, so that they will then operate autonomously. Due to the fact that the two units do not need the same complex logic, one unit can be equipped with more functional modules. Such a module can for example be a telecommunication module which includes a SIM card. In this way, parameters such as the course of the road and the like can be retrieved online. In addition, statistics can be retrieved from or uploaded to the internet. Databases located on the internet can be supplied with suitable data and the user can look at them later. Information can also be transmitted to communication partners in relevant networks (Facebook). Furthermore, it is conceivable that alarm messages are transmitted to hospitals or suitable doctors when the sensor parameters indicate that the user is in a critical state.

If a navigation device or a smartphone with a navigation program is used, navigation can be handed over to the device according to the present disclosure with a defined function key or a suitable control. If this is done, a switch is made from the visual mode to the tactile mode. This can for example be advantageous if someone enters a parking garage with a vehicle and then wants to continue on foot to his destination.

In another embodiment, sensors are provided which detect that the units are moved towards each other and/or are brought in contact with each other in order to trigger a function. These modules can be designed as wireless modules which detect how far away the other device is, based on the fact how strong the relevant signals of the other device are. If for example both devices are close to each other, this can be used to start or stop navigation.

In addition it can also be conceived that the devices according to the present disclosure have a small display in the form of an arrow which points to a direction which should be taken.

In a possible embodiment, the unit is arranged in a watertight housing which is resistant to shocks and impacts. This could for example be a plastic housing which can be incorporated in a rubber wristband. This means the unit can be introduced in the rubber wristband and used therein but can alternatively also be worn on other parts of the body, as described above. Said housing is in some cases slightly curved, so that the stimulation module can rest optimally against the body. It can also be conceived that the contact surface has a slightly curved rubber surface which lies flat against the skin of the user in an optimal manner.

Power supply can be done by converting mechanical energy of motion to electric energy. Solar cells can also be envisaged. Energy can also be stored in a rechargeable battery which is charged through an external interface. In some cases, a USB interface can be used for charging.

Other parts of the present disclosure are navigation methods using a device as described above, wherein navigation instructions are forwarded to a user as tactile stimuli.

Yet another part of the present disclosure is a training method and/or monitoring method using a device as described above, wherein training information or monitoring information for a user is forwarded to the user as tactile stimuli.

The sports activity of running a marathon serves as an exemplary embodiment for this. To achieve an optimal result, the heart rate of the runner must be monitored and controlled at all times. If he is outside an optimal heart rate range, several haptic signals are used to make him aware of the fact that he needs to adjust his heart rate (positively or negatively).

The device and method described herein make it possible to improve the methods and devices described at the beginning and to create a high added value, based on the individual tactile control of training and connected applications (software for tablets, phones, computers).

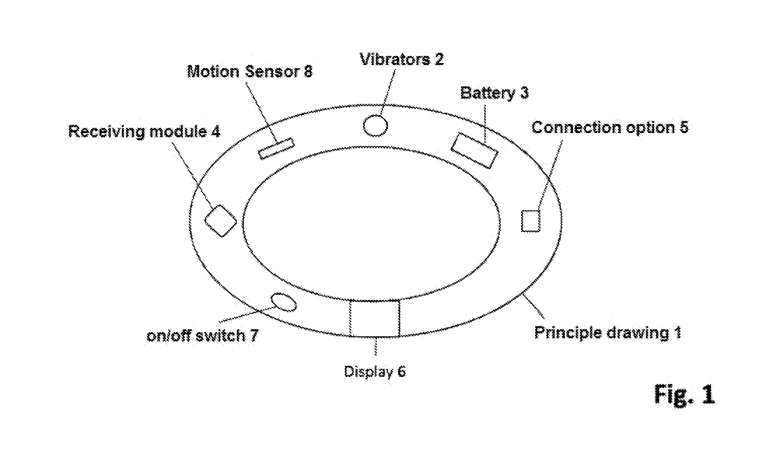

FIG. 1 shows a possible wristband by way of a schematic diagram including the essential functional elements that are involved in the method and in the device according to the present disclosure.

The mechanical vibrators/stimulation modules 2 shown in FIG. 1 serve as signalling elements. The receiving module provides the possibility for several devices/wristbands/stimulation modules to be triggered separately of each other, thus enabling navigation by way of haptic sensations (mechanical vibrations). They can be different in terms of type, position, material and shape. A battery 3, which is rechargeable, can be charged by connecting a power supply cable (not shown) to a terminal 5. Alternatively a power generator can be provided which converts kinetic energy into electric power which is then stored in the battery. One option could be wireless inductive charging. Another conceivable option could be a piezoelectric plastic material (nanogenerator). Any other way to supply power to the bands could be envisaged.

A receiving module 4 is provided which processes incoming signals and functions to control the vibrators/stimulation modules and the display. The receiving module can incorporate any other components that are able to receive or control signals.

A terminal 5 serves to make contact with a current-carrying cable or a power supply, as described above. It is also conceivable that data is downloaded or the receiving module is configured to suit requirements.

A display 6 offers different ways of presenting information. Among other things, arrows, lines, symbols, alphanumeric characters, images and moving images can be shown. It is also conceivable to use LEDs which can convey information.

An on/off switch enables the device to be switched on and off and further serves to select or switch off voice control. It is also conceivable that a particular timed button combination is used to initiate correlating/pairing of the wristband with the external navigation device.

Furthermore a motion sensor 8 is used which makes it possible to measure distances or detect movement in three-dimensional space. This can be a gyroscope.

In the navigation system of the type described at the beginning, the object of the present disclosure is achieved by the fact that guidance to a destination is experienced in a haptic manner (mechanical vibrations) and attention is not diverted too much by a screen. In this way, a multi-use navigation method is provided which makes it possible to pay more attention to the environment during navigation. Such a navigation system helps to find one's way on the road, when rambling, doing sports and in unfamiliar surroundings.

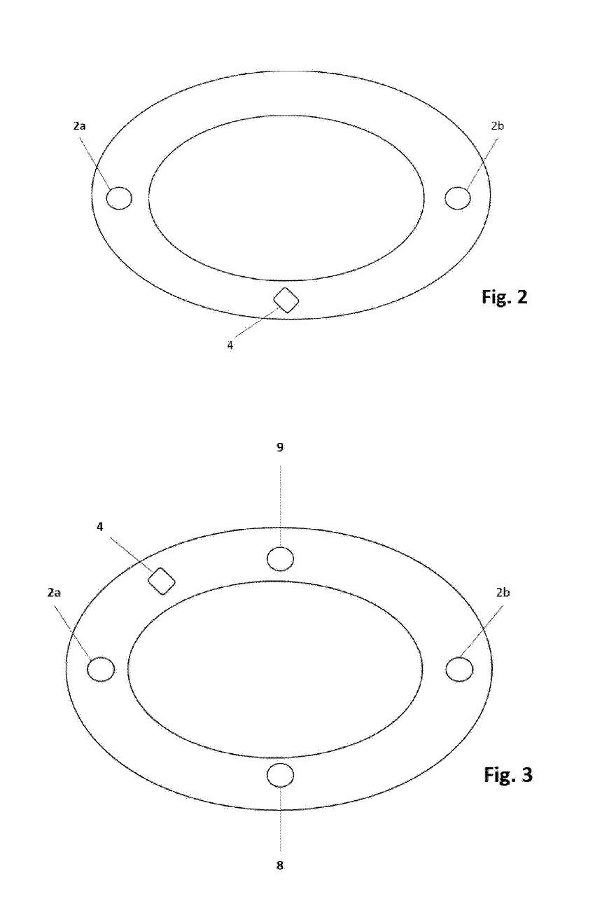

FIG. 2 shows a device according to FIG. 1 including two stimulation modules 2a/2b which are arranged on the right and left and can each be activated by the receiving module 4. Further stimulation modules can be incorporated but are not shown.

FIG. 3 shows the device according to FIG. 2 including an additional sensor 9 which can, e.g., record the pulse rate, blood pressure, temperature, etc., to transmit them to the central unit.

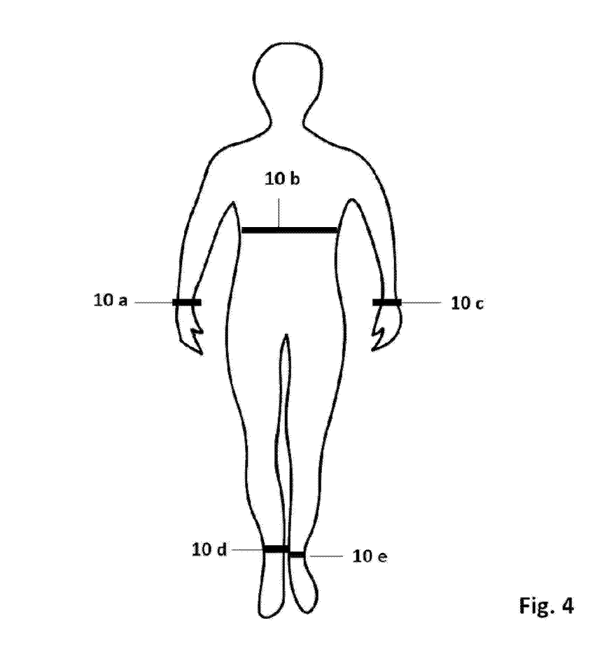

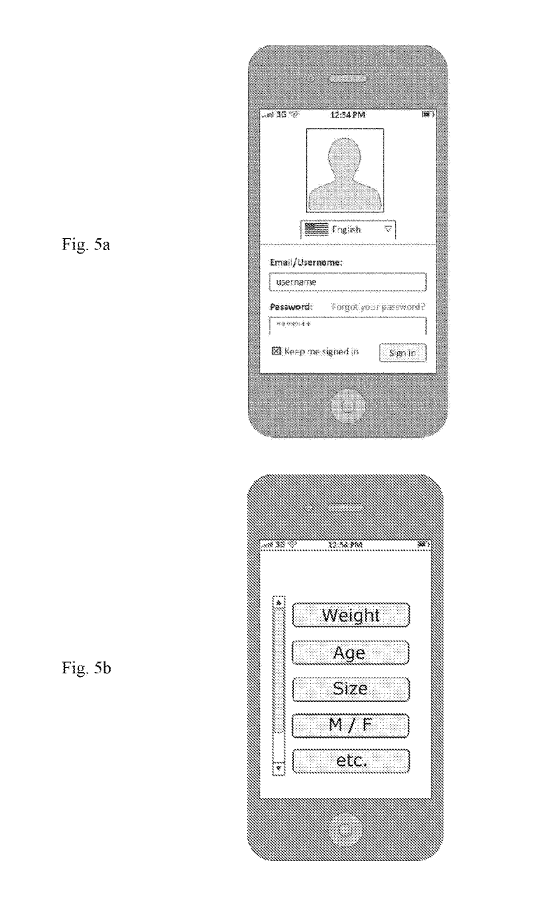

FIG. 4 shows possible ways of arranging the device: on the arm (right/left) 10a/10c, on the thorax 10b and on the legs 10d/10e.

Many other embodiments are conceivable if the shape, material selection, type and position of the vibration sensors are changed or other manufacturing processes are used. Therefore the attached figures only serve a better understanding of the device; they show only one of many possible embodiment variants.

The navigation device for the navigation method comprises, e.g., two identical wristbands 10a/10c with built-in mechanical vibration elements/sensors. They serve as signalling elements. The wristbands include receiving modules which are contacted by a transmitting module from a mobile terminal (smartphone). The signals are received wirelessly (Bluetooth/Zigbee) and bring about mechanical vibrations on the wristbands, which enable the individual wristbands to be triggered separately of each other, thus enabling navigation by way of haptic sensations (mechanical vibrations).

In one embodiment, it is possible to transmit a direction, change of direction and other signals based on different signal sequences.

The sensors for mechanical vibrations (haptic sensation) can also be included in items of clothing in order to enable navigation in this way. Alternatively the sensors for mechanical vibrations (haptic sensation) can also be included in shoes in order to enable navigation in this way.

It is also conceivable that the sensors for mechanical vibrations (haptic sensation) are included in gloves in order to enable navigation in this way.

In a possible embodiment, a single band is coupled with a smartwatch (watch phone) and the watch functions as a second band (by suitable programming) in order to enable navigation.

If the device is coupled with a navigation device of a car, a function key can be provided which, if pressed, causes the wristbands to take over guidance to the destination (navigation) once the vehicle is left.

The wristbands can make it possible to navigate through large buildings (indoor), trade fairs and hotels.

In a possible embodiment, the wristbands are provided with their own SIM card, thus enabling autonomous navigation (without a smartphone). Furthermore, the course to be run can be directly shown in the social network in this way.

In tourism, the wristbands can make it possible to navigate through leisure parks, cities, beaches, shopping centres and during sports events (marathon/leisure events).

In another embodiment, the wristbands are configured such that, when the wristbands are moved towards each other and/or are brought in contact with each other, they will play an audio file which makes it possible to retrieve tourist information in unfamiliar surroundings. It is also conceivable to enter a destination using voice commands.

In another embodiment, vibrating wristbands are also used to control training (sports). Mechanical vibrations can give a signal to the sportsman telling him whether he should run faster or slower or whether the intensity of training is correct. Here the motion sensor included in the wristband detects and records movement (e.g., squats, etc.).

One embodiment includes at least two electrodes with a high input resistance on the breast and at least one reference electrode on the back, with which the physical state of the body can be detected.

The figures show an application in which specific parameters can be set on a mobile terminal (smartphone), which are then used to control and monitor training. For example, the individual data of the person and the training profile are entered. A calendar can then be used to visualize the development of training and performance.

As an alternative in the present disclosure, information can be entered giving voice commands through a microphone.

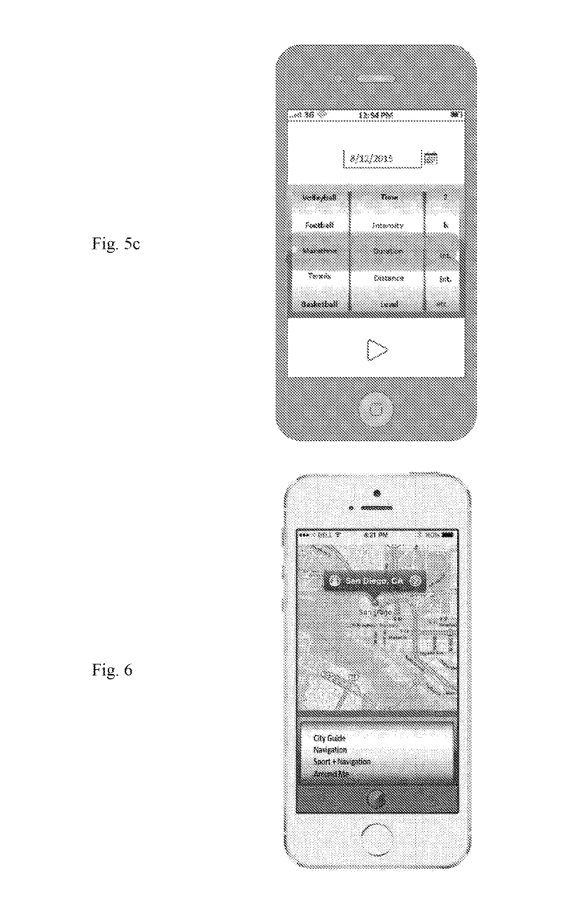

FIG. 6 shows a navigation app which is designed to transmit signals to the units that are located on the right and left of the body. In this way, slight stimuli can be given to a pedestrian even before he arrives at a turn-off, so that he knows he will have to change direction soon. When he is near the turn-off or should actually turn off, the stimuli increase until a continuous intense stimulus is given. These stimuli may also depend on the speed of movement. This means these stimuli which predict a turn-off are output earlier if the speed is high. It is also conceivable that a combination of left and right stimuli is intended to indicate that only a slight turn to the right is required or that the user should continue straight ahead. This can be helpful in the area of a crossing. Thus a plurality of combined stimuli can be envisaged which are intended to give a navigation instruction. The user can make an individual setting/adjustment on his navigation device, so that it will be easy for him to understand and intuitively respond to the stimuli.

### Reference Number List

1 Schematic diagram including the essential functional elements
2 Mechanical vibrators/stimulation module
3 Battery
4 Receiving module
5 Terminal for a current-carrying cable or a power supply
6 Display
7 On/off switch
8 Motion sensor

1. A device designed to be worn on the human body, including attachment means which place the device such that it rests directly against a body part, and at least one functional module which is connected to the attachment means, wherein the functional module comprises a wireless receiver and at least one tactile stimulation module;
wherein the stimulation module is designed to forward tactile stimuli to the body part to which it is attached, and
wherein the wireless receiver is designed to receive instructions and to activate the stimulation module.

2. The device according to claim 1, wherein the attachment means are a closable band and/or a pocket/receptacle in items of clothing, watches, smartphones, walking sticks, glasses, shoes, gloves, swimming accessories, jewellery, bicycle grips and/or saddles which allow direct contact with a body part.

3. The device according to claim 1, comprising several stimulation modules at different positions within the functional module which are spaced apart, so that the different positions are detectable by the body part.

4. The device according to claim 1, wherein the stimulation module produces different tactile stimulation patterns that are activatable from outside, comprising one or more of the following parameters: intensity, frequency, duration, time interval, and signal sequence.

5. The device according to claim 1, wherein the stimulation module works in a vibrotactile, electrotactile and mechanotactile manner.

6. The device according to claim 1, comprising at least two units, each of which includes an attachment means, functional module and stimulation module, which are arranged on a body part so that they are spaced apart but are controlled jointly and/or selectively with a central unit.

7. The device according to claim 6, wherein the at least two units are wristbands/ankle bands are attached to the right arm/foot and left arm/foot in order to receive right and left stimuli from the stimulation modules,
and/or the at least two units are attached in left and right shoes in order to receive right and left stimuli from the stimulation modules,
and/or wherein the at least two units are attached in left and right areas of a handlebar of a vehicle in order to receive right and left stimuli from the stimulation modules,
and/or wherein the at least two units are attached in left and right gloves in order to receive right and left stimuli from the stimulation modules,
and/or wherein the at least two units are attached in left and right areas of an item of clothing in order to receive right and left stimuli from the stimulation modules.

8. The device according to claim 1, wherein the functional module includes sensors for detecting states of the user.

9. The device according to claim 8, wherein the stimulation modules are activatable on the basis of the sensor information.

10. The device according to claim 8, wherein on the basis of information from the sensors, the stimulation module is activated such that training methods and prescribed load values, such as extent, duration of load, duration of breaks, repetitions, and intensity such as frequency, speed and/or load, are controllable.

11. The device according to claim 6, wherein if two units are used, one unit serves as a master unit which controls the other unit as a slave unit.

12. The device according to claim 11, wherein the master unit comprises a receptacle for a SIM card and comprises wireless functional modules.

13. The device according to claim 1, further comprising a handover of navigation from visual navigation to tactile navigation with a function key.

14. The device according to claim 6, wherein sensors are provided which detect that the units are moved towards each other and/or are brought in contact with each other in order to trigger a function.

15. A navigation method using a device according to claim 1, wherein navigation instructions are forwarded to a user as tactile stimuli.

16. A training method and/or monitoring method using a device according to claim 1, wherein training information or monitoring information for a user is forwarded to the user as tactile stimuli.

17. The device according to claim 6, wherein the central unit includes a navigation application and directional instructions are transmitted to the relevant units.

18. The device according to claim 8, wherein said sensors for detecting states of the user are selected from the group consisting of one or more of the following: pulse rate sensor, blood pressure sensor, acceleration sensor, thermosensor, and infrared sensor.

19. The device according to claim 18, wherein said states of the user are detected and transmitted to central mobile units using a transmitter included in the functional module.

20. The device according to claim 9, wherein the stimulation modules are activated on the basis of the sensor information when limits are exceeded/not reached and/or curves and/or increase data are/is exceeded/not reached.

21. The device according to claim 11, wherein the unit which serves as master includes further modules which allow autonomous navigation and/or recording and processing of sensor information in order to transmit control signals to the slave unit.
